(19) United States
(12) Patent Application Publication
(10) Pub. No.: US 2025/0298394 A1
(43) Pub. Date: Sep. 25, 2025

(54) DISTRIBUTED CONTROL NODE (DCN) REDUNDANCY

(71) Applicant: Yokogawa Electric Corporation, TOKYO (JP)

(72) Inventor: Patrick Clay, Frisco, TX (US)

(21) Appl. No.: 18/614,295

(22) Filed: Mar. 22, 2024

(51) Int. Cl. G05B 19/4155

(52) U.S. Cl. CPC G05B 19/4155; G05B 2219/33273

(57) ABSTRACT

Methods, systems, and apparatus for implementing a redundant DCN system over a process automation network. In one aspect, a redundant DCN system includes a primary DCN, a backup DCN, and a keep alive process configured to determine whether the primary DCN becomes unavailable, wherein in response to the primary DCN being determined as unavailable, the backup DCN is reassigned as a new primary DCN, and assumes functions previously executed by the former primary DCN. Each DCN in the redundant DCN system may have a unique virtual IP address or transfer a common virtual IP address. Virtual IP addresses may impact communications between DCNs and other devices.

### BACKGROUND

Process automation facilities may include a myriad of sensors, actuators, and distributed control nodes (DCNs) that cooperate to perform a variety of different tasks, including managing process control loops. Many of these tasks are mission critical and/or involve processes that are potentially dangerous if not properly controlled. Consequently, failure of any constituent component can result in failure of the larger task, which may be costly at best and catastrophic at worse. Having a redundant DCN system in place enables a facility to continue operations, if a primary DCN fails, by enabling quick changeover from a faulted primary DCN to one or more backup DCNs.

### SUMMARY

Implementations are described herein for increasing and/or maintaining availability of DCNs in process automation networks. More particularly, but not exclusively, implementations are described herein for determining availability of a primary DCN based on a keep alive process and reassigning one or more backup DCNs in communication with the primary DCN as a new primary DCN in response to a determination that the primary DCN became unavailable.

In various implementations, a redundant distributed control node (DCN) system may include: one or more shared output channels; a private network that is at least logically separated from a process automation network; a primary DCN to subscribe to one or more remote data feeds based on subscription data and drive one or more of the shared output channels based on one or more of the remote data feeds; and one or more backup DCNs that are communicatively coupled with the primary DCN via the private network. In various implementations, a virtual IP address, used by the redundant DCN system to exchange data over the process automation network, may be transferable between the primary DCN and one or more of the backup DCNs. In various implementations, the primary DCN may be configured to transmit, to one or more of the backup DCNs via the private network, the subscription data of the primary DCN, and the subscription data may be operable to subscribe one or more of the backup DCNs to one or more of the remote data feeds. In various implementations, a keep alive process may determine whether the primary DCN has become unavailable, and trigger reassignment of one or more of the backup DCNs as a new primary DCN. In various implementations, the new primary DCN may subscribe to one or more of the remote data feeds based on the subscription data to drive one or more of the shared output channels. In various implementations, reassignment as the new primary DCN may include transferring the virtual IP address from the primary DCN to the new primary DCN.

In various implementations, the keep alive process may be hosted on one or more of the backup DCNs. In various implementations, the keep alive process may be hosted on each DCN of the one or more backup DCNs.

In various implementations, the keep alive process may be hosted on a processing node, separate from the one or more backup DCNs. In various implementations, the processing node may be integral with the redundant DCN system. In various implementations, the primary DCN may be configured to transmit the subscription data periodically.

In various implementations, the primary DCN may be configured to transmit the subscription data whenever the subscription data of the primary DCN is altered. In various implementations, the subscription data of the primary DCN may be altered responsive to the primary DCN subscribing to a new node. In various implementations, the subscription data of the primacy DCN may be altered responsive to the primary DCN modifying an existing subscription.

In various implementations, the new primary DCN may load the subscription data responsive to a determination that the primary DCN has become unavailable. In various implementations, the new primary DCN, responsive to loading the subscription data, may subscribe to one or more of the remote data feeds, and drive one or more of the shared output channels based on one or more of the remote data feeds.

In various implementations, subsequent to reassignment of one or more of the backup DCNs as the new primary DCN, and responsive to the primary DCN being made available again, the primary DCN may be assigned as another backup DCN, of the one or more backup DCNs, while the virtual IP address remains reassigned to the new primary DCN.

In various implementations, the private network may be implemented using one or more of ethernet, serial, or bus communication technology. In various implementations, the primary DCN or the new primary DCN may share the virtual IP address with another DCN. In various implementations, the keep alive process may determine a status of the primary DCN periodically and/or in response to a triggering event.

In another aspect, a method may be implemented by one or more processors and may include: identifying one or more shared output channels and a private network over which one or more backup DCNs are communicatively coupled with a primary DCN; determining, based on a keep alive process, whether the primary DCN, that is subscribed to one or more remote data feeds to drive one or more of the shared output channels based on one or more of the remote data feeds, has become unavailable, wherein the primary DCN is subscribed to the one or more remote data feeds based on subscription data and transmits the subscription data to one or more of the backup DCNs via the private network; and causing, in response to determining that the primary DCN has become unavailable, reassignment of one or more of the backup DCNs as a new primary DCN, wherein reassignment as the new primary DCN includes transfer of a virtual IP address of the primary DCN to the new primary DCN, and wherein the new primary DCN subscribes to one or more of the remote data feeds based on the subscription data. In various implementations, the keep alive process may be hosted on one or more of the backup DCNs.

In another aspect, redundant DCN system may include: one or more computers comprising one or more processors, and one or more storage devices storing instructions that are operable, when executed by the one or more computers, to cause the one or more processors to perform operations comprising: determining whether a primary DCN, that is currently or formerly subscribed to one or more remote data feeds to drive one or more shared output channels based on one or more of the remote data feeds, has become unavailable; identifying one or more backup DCNs that are communicatively coupled with the primary DCN via a private network logically separated from a process automation network associated with the redundant DCN system, wherein a virtual IP address, used by the redundant DCN system to exchange data over the process automation network, is transferable between the primary DCN and one or more of the backup DCNs, and wherein subscription data of the primary DCN is transmitted to one or more of the backup DCNs via the private network; and reassigning, in response to determining that the primary DCN has become unavailable, one or more of the backup DCNs as a new primary DCN, wherein reassignment as the new primary DCN includes transferring the virtual IP address from the primary DCN to the new primary DCN.

In various implementations, the new primary DCN may subscribe to one or more of the remote data feeds based on the subscription data.

It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

### BRIEF DESCRIPTION OF THE DRAWINGS

FIG. 1 schematically depicts an example environment in which selected aspects of the present disclosure may be implemented.

FIG. 2 schematically depicts an example environment in which selected aspects of the present disclosure are, or have been, implemented.

FIG. 3 schematically depicts a redundant DCN system that includes a private network communicatively coupling a primary DCN with one or more backup DCNs, and a keep alive process used to determine whether the primary DCN is unavailable.

FIG. 4 schematically depicts a redundant DCN system subsequent to one or more selected aspects of the present disclosure being implemented, including reassignment of a backup DCN as a new primary DCN, transfer of a virtual IP address of the primary DCN to the new primary DCN, subscription of the new primary DCN to remote data feeds, and driving of output channels by the new primary DCN.

FIG. 5 schematically depicts an example method for performing aspects of the present disclosure.

FIG. 6 schematically illustrates an example computer architecture on which selected aspects of the present disclosure may be implemented.

### DETAILED DESCRIPTION

Implementations are described herein for increasing and/or maintaining availability of DCNs in process automation networks. More particularly, but not exclusively, implementations are described herein for determining availability of a primary DCN based on a keep alive process and reassigning one or more backup DCNs in communication with the primary DCN as a new primary DCN in response to a determination that the primary DCN became unavailable.

A DCN may include one or more input-output (I/O) channels associated with various types of equipment in a process automation facility. Output channels may be associated with output devices such as actuators, valves, dampers, etc. Input channels may be associated with input devices such as various types of sensors, flow meters, compute nodes, etc. A DCN may drive output channel(s) controlling output device(s) based on data received from one or more data sources, such as one or more remote DCNs (or components thereof) to which the DCN is subscribed.

In some implementations, DCNs may share I/O channels, enabling each DCN sharing an I/O channel to receive or transmit information using the I/O channel. In some implementations, DCNs may not share I/O channels, preventing DCNs that are not associated with an I/O channel from receiving or transmitting information with the I/O channel. In various implementations, a DCN may contribute to control of one or more pieces of equipment (e.g., actuators, valves, dampers, etc.) based on data received from a sensor elsewhere in the process automation facility.

Process automation equipment such as DCNs may be configured to communicate with other process automation equipment using various open (e.g., non-proprietary) and/or standardized communication protocols, which will be described herein as “cross-platform.” Cross-platform communication protocols may be governed by various regulations and/or standards, such as the Open Platform Communication (OPC) uniform architecture (UA). Thus, while in various examples described herein, a DCN is described as hosting one or more “OPC UA clients” and/or one or more “OPC UA servers,” this is not meant to be limiting. DCNs may host other types of cross-platform clients and/or cross-platform servers; OPC UA is just one example.

In some instances, a DCN may become unavailable. The cause of a DCN becoming unavailable may vary, but can include a malfunction or a failure. Unavailability of a DCN can have adverse impacts on facility operations. For instance, OPC UA client(s) may be subscribed to OPC UA server(s), and failure of one or the other may have adverse consequences. When a DCN becomes unavailable, functions performed by other components, such as other DCNs (or OPC UA clients hosted thereon), that subscribed to the DCN to not be performed, to be performed improperly, or to be performed based on inaccurate information. For example, suppose a DCN to which another DCN that controls a valve is subscribed, becomes disabled. This could result in failure of the subscribing DCN to properly manage flow going through the valve, which could be adversely significant on its own, or could compound to further adversely impact a larger process such as a control loop.

To avoid and/or mitigate adverse impacts to system processes in response to a primary DCN being unavailable, one or more other DCNs of a redundant DCN system may be designated as “backup” DCNs. Backup DCNs may have similar or identical properties compared to a primary DCN, or may have alternative properties. In some instances, alternative properties may make a backup DCN less susceptible to unavailability. Backup DCNs may be reassigned as a “new primary” DCN in response to a determination that a former primary DCN has become unavailable. Some implementations may include a plurality of DCNs being designated backup DCNs, and some implementations may further include processes to run on backup DCNs prior to being reassigned as a new primary DCN. Quantities and qualities of DCNs designated as primary or backup DCNs are highly customizable and adaptable for facility requirements.

In various implementations, two or more DCNs of a redundant DCN system may be communicatively coupled with each other using a private network. The private network may be logically separated from, but connected to, a larger process automation network via one or more ingress points. The private network may be implemented using a variety of different communication technologies, such as Ethernet, serial busses, Wi-Fi, Bluetooth, Zigbee, or Z-Wave, IP subnets, etc.

In some implementations, a single virtual IP address may be allocated to, and transferable between, a group of DCNs that are communicatively coupled via a private network. Additionally, in some implementations, each DCN may have its own non-virtual (or “traditional,” “normal”) IP address. A virtual IP address may be transferrable between multiple DCNs, for instance, by mapping (and/or remapping) the virtual IP address to different non-virtual IP addresses of the DCNs. Thus, a virtual IP address can serve as a single ingress/egress point to/from a redundant DCN system that includes a primary DCN and one or more backup DCNs communicatively coupled via a private network.

In various implementations, devices such as DCNs may be configured to communicate with specific virtual IP addresses. For example, when an OPC UA client hosted by a first DCN subscribes to an I/O channel (e.g., sensor) hosted by a second DCN, a virtual IP address used by the second DCN may be provided to the OPC UA client hosted by the first DCN. The OPC UA client on the first DCN may thereafter use this virtual IP address to communicate with an OPC UA server hosted by the second DCN, e.g., to retrieve sensor data from an I/O channel of the second DCN. If the second DCN becomes disabled, the virtual IP address may be transferred to a third “backup” DCN residing on the same private network as the second DCN. The OPC UA client on the first DCN may continue using the same virtual IP address, except now to communicate with an OPC UA server hosted by the third DCN.

In some implementations, each primary and backup DCN of a redundant DCN system may be communicatively coupled with the larger process automation network, directly or indirectly, by way of their traditional/non-virtual IP addresses. The single virtual IP address transferable between DCNs may be used to limit how other nodes of the larger process automation network are able to communicate with these DCNs, e.g., via the single ingress/egress point mentioned previously. Additionally or alternatively, in some implementations, a redundant DCN system may include a single network interface that connects the redundant DCN system to the larger process automation network. Within the redundant DCN system, and in particular, using the private network that is logically contained within the redundant DCN system, a virtual IP address may be transferred between the multiple DCNs as needed (e.g., when a primary DCN malfunctions).

Subscription data may indicate one or more subscriptions of a DCN (e.g., by an OPC UA client hosted thereon) to one or more remote data feeds and/or output channels. Subscription data associated with a primary DCN may be shared with backup DCNs. For example, subscription data may be shared to enable a backup DCN to take over one or more functions performed by the primacy DCN by subscribing to one or more remote data feeds used by the primary DCN to perform the functions. Accordingly, output channels that a primary DCN drives may also be shared among DCNs of a redundant set. As discussed previously, a plurality of DCNs may be designated as backup DCNs and data, including subscription data, may be shared differently or identically among each of a plurality of backup DCNs.

A “keep alive” program may be implemented to determine whether primary DCN is available or unavailable. The keep alive program may be configured to monitor whether a DCN is unavailable periodically, continuously, and/or on demand. The keep alive program may execute among one or more of a primary DCN, a backup DCN, or an independent node that is separate from the primary or backup DCNs. For example, a respective instance of a keep alive program may execute on each backup DCN of a plurality of backup DCNs. In response to an instance of the keep alive program determining that a primary DCN is unavailable, the instance of the keep alive program may reassign a backup DCN as a new primary DCN. Reassignment of a backup DCN as a new primary DCN may be based on one or more of several factors, such as hardware capabilities, software capabilities, and availability of the particular DCN.

Subsequent to a backup DCN being reassigned as a new primary DCN, the new primary DCN may take over role(s) formerly performed by the previous primary DCN. The new primary DCN may use subscription data provided by the previous primary DCN to quickly adapt to the updated role(s). For example, based on the subscription data, the new primary DCN may drive one or more of the same output channels as the old primary DCN did, and subscribe to one or more of the same remote data feeds as the old primary DCN did.

In some instances, an old primary DCN may become available again. An old primary DCN made available again may be reassigned as a backup DCN. Alternatively, the new primary DCN may be reverted back to a backup DCN status, and the original primary DCN may be reverted to its former status. Protocols for old primary DCNs coming back online are customizable and may be adapted for facility requirements.

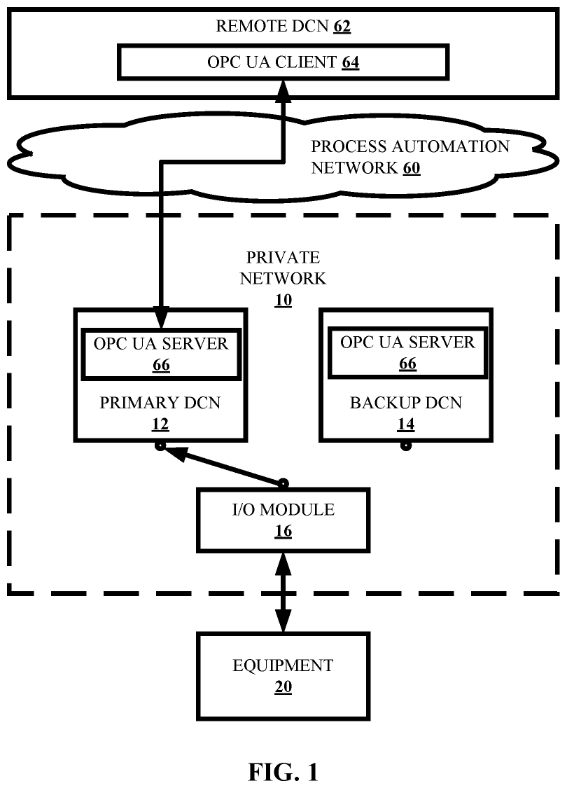

FIG. 1 schematically depicts an example environment in which selected aspects of the present disclosure may be implemented, in accordance with various embodiments. An OPC UA client 64 hosted by a remote DCN 62 may subscribe to information of DCN 12, or more particularly, information of OPC UA server 66 that is hosted by DCN 12. DCNs 62 and 12 may be communicatively coupled via a larger process automation network 60. DCN 12 may be connected with I/O module 16 which provides information from equipment 20. For illustrative purposes, equipment 20 could include a sensor that generates sensor data that DCN 12 retrieves from I/O module 16 and publishes. OPC UA client 64 may subscribe to this data in order to control another piece of equipment (not depicted), such as an actuator, value, or damper, in a process automation facility.

DCN 12 may be communicatively coupled with other components of a redundant DCN system via private network 10. Private network 10 may be logically separate from a larger process automation network 60 and may include one or more ingress/egress points with the larger process automation network 60. Private network 10 may communicatively couple primary DCN 12, one or more backup DCNs 14, and I/O module 16. I/O module 16 may be configured to receive information from, and/or provide information to each primary DCN 12 and backup DCN 14.

As discussed previously, a single virtual IP address may be allocated to and transferred between primary DCN 12 and backup DCN(s) 14. Equipment 20 and OPC UA client 64, which may be located outside of private network 10, may perceive primary DCN 12 and backup DCN 14 as being a single entity since only one of primary DCN 12 and backup DCN 14 use the virtual IP address at a time. In various implementations, the virtual IP address may be transferred between primary DCN 12 and backup DCN 14, such that both primary DCN 12 and backup DCN 14 do not concurrently share a virtual IP address. Put another way, the virtual IP address that is transferable between DCNs 12 and 14 may serve as the single ingress/egress point mentioned previously.

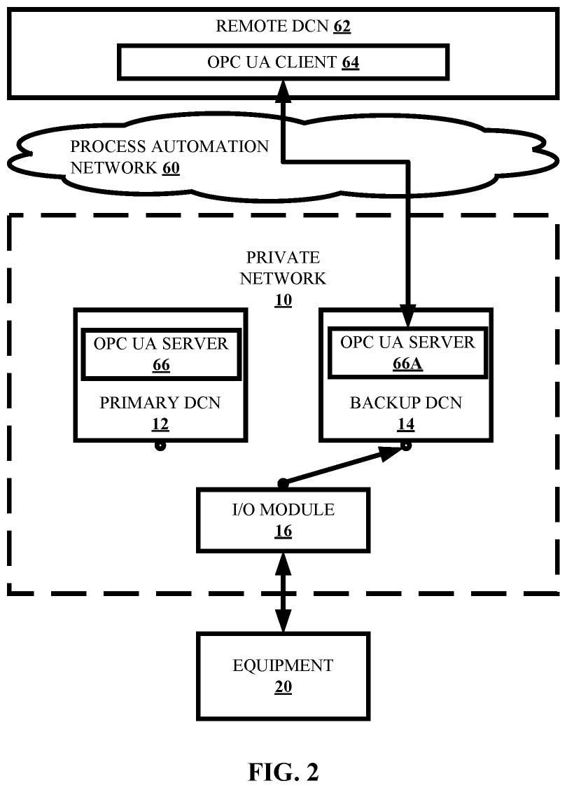

FIG. 2 schematically depicts an example environment in which selected aspects of the present disclosure are, or have been, implemented. For example, primary DCN 12 is depicted as previously or currently being unavailable. As discussed herein, DCN unavailability may be attributed to a variety of causes, including but not limited to failure, malfunction, disconnection, or a larger facility issue.

In response to primary DCN 12 being unavailable, a keep alive process (not depicted) may cause backup DCN 14 to take over the function of primary DCN 12. Put another way, a keep alive process may reassign backup DCN 14 as a new primary DCN, e.g., by reassigning the virtual IP address formerly assigned to primary DCN 12 to backup DCN 14. Based on backup DCN 14 being reassigned as a new primary DCN, I/O module 16 may forward information (e.g., sensor data) associated with (e.g., generated by) equipment 20 to backup DCN 14. Similarly, based on backup DCN 14 being reassigned as a new primary DCN, backup DCN 14 may host OPC UA server 66A and exchange information with OPC UA client operating on remote DCN 62.

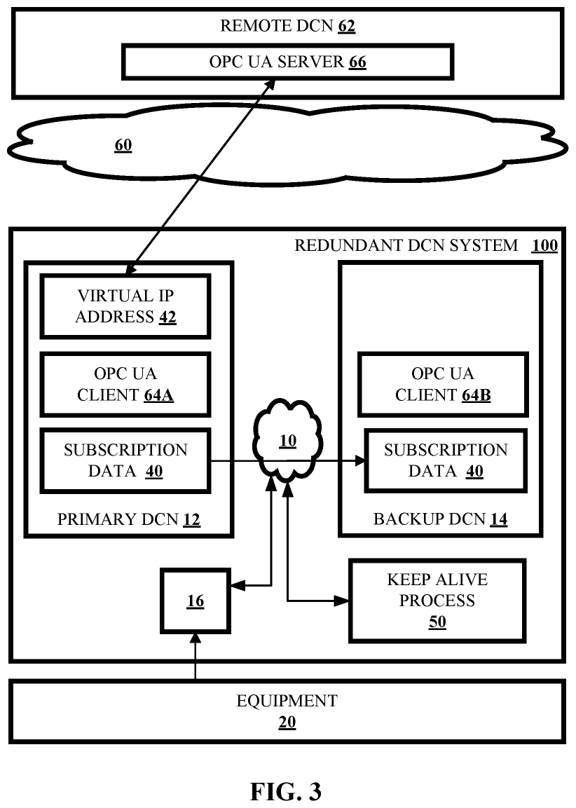

FIG. 3 schematically depicts an environment in which selected aspects of the present disclosure may be implemented. The environment may include equipment 20 remote DCN 62a remote DCN 62 that operates, as a cross-platform server, an OPC UA server 66. The remote DCN may be connected to a redundant DCN system 100 via one or more process automation networks 60. One or more pieces of equipment (e.g., sensors, actuators) may be operably coupled with redundant DCN system 100 as well.

Within redundant DCN system 100, private network 10 may communicatively couple a primary DCN 12, a backup DCN 14, I/O module 126, and one or more keep alive processes 50. As discussed herein, the private network 10 may be at least logically separated from process automation network 60. For example, private network 10 may be implemented as a subnet, e.g., of larger process automation network 60 or separately therefrom. Additionally or alternatively, private network 10 may only carry traffic between DCNs 12 and 14, as well as keep alive process 50 (and an I/O module, where applicable).

Private network 10 being “private” enables DCNs 12, 14 included in redundant DCN system 100 to readily and privately transfer information such as subscription data 40 and/or virtual IP addresses 42. In many implementations, components outside the private network 10, such as equipment 20 and remote DCN 62, are uninformed as to which DCN included in the private network 10 is processing and exchanging information. That is, devices outside redundant DCN system 100 may only seek to exchange information based on a particular IP address, and whether that particular IP address is transferred from a primary DCN 12 to a backup DCN 14 is not revealed to them.

Accordingly, primary DCN 12 includes a virtual IP address 42. As discussed herein, remote DCN 62, and more particularly, OPC UA server 66, may be configured to direct subscribed to data (e.g., a sensor reading) to specific virtual IP addresses, such as virtual IP address 42 associated with primacy DCN 12. If keep alive process 50 determines that primary DCN 12 has become unavailable, keep alive process 50 and/or backup DCN 14 may ensure that backup DCN assumes the same virtual IP address 42 previously held by primary DCN 12. Subsequently, OPC UA server 66 hosted by remote DCN 62 may feed identical data (e.g., sensor reading(s)) to backup DCN 14 as OPC UA server 66 would have with primary DCN 12 based on backup DCN 14 appearing under the same identity attributed to former primary DCN 12 by way of virtual IP address 42.

Primary DCN 12 and backup DCN 14 may also include respective instances of cross-platform clients, OPC UA client 64A and OPC UA client 64B, respectively, as well as subscription data 40. As shown by the arrow, subscription data 40, like virtual IP address 42, may be exchanged between primary DCN 12 and backup DCN 14. Subscription data 40 may indicate which remote data feeds, published by OPC UA server(s) hosted on remote DCN(s), that a DCN (and more particularly, a cross-platform client such as an OPC UA client 64 (see FIGS. 1-2) is subscribed to. Subscription data 40 may also indicate which equipment 20 a DCN “drives” (e.g., provides output to). For instance, subscription data may indicate that OPC UA client 64A is subscribed to a data feed published by OPC UA server 66 hosted by remote DCN 62.

Subscription data 40 can be unique or identical depending on whether or when it was last shared between primary DCN 12 and backup DCN 14. In some implementations, primary DCN 12 and backup DCN 14 sharing subscription data can make reassignment more efficient (should backup DCN 14 need to be reassigned as a new primary DCN).

Keep alive process 50 may determine whether a primary DCN 12 becomes unavailable. If primary DCN 12 becomes unavailable, backup DCN 14 may be reassigned as the new primary DCN. As discussed herein, keep alive process 50 may be performed periodically, continuously, on demand, and/or in response to certain conditions. For example, keep alive process 50 may be configured to execute daily, continuously, by demand of one or more user accounts, and/or in response to temporary brownouts and blackouts.

While FIG. 3 depicts keep alive process 50 as a standalone process that is connected to other components of redundant DCN system 100 via the private network 10, some implementations may include the keep alive process 50 as occurring on one or more of primary DCN 12, backup DCN 14, a separate node included in the private network 10, a separate node included in the process automation network 60, and a separate node outside of process automation network 60. In some instances, the separate node is integral with the redundant DCN system. Moreover, in some implementations, multiple instances of the keep alive process 50 may run consecutively or concurrently. Further, in some implementations a single instance of the keep alive process 50 may run on a plurality of devices, such as primary DCN 12 and backup DCN 14. In implementations in which a plurality of backup DCNs are implemented, each of the plurality of backup DCNs may host an instance of keep alive process 50.

Keep alive process 50 may communicate continuously or intermittently with one or more of primary DCN 12 and backup DCN 14. In some implementations, keep alive process 50 communicates with both primary DCN 12 and backup DCN 14 to identify status of each DCN. Thus, while a function of keep alive process 50 is to identify a status of primary DCN 12 (particularly, whether primary DCN 12 is unavailable), keep alive process 50 may also determine a status of one or more other DCNs including backup DCN 14. By determining a status of both primary DCN 12 and backup DCN 14, keep alive process 50 may preemptively identify faults within a redundant DCN system. For example, by identifying that primary DCN 12 is available, but backup DCN 14 is unavailable, keep alive process 50 may determine that a different DCN should be reassigned as a backup DCN.

In some implementations keep alive process 50 may contribute to a ranking of backup DCNs. For example, in a redundant DCN system (e.g., 100) including a plurality of potential backup DCNs, keep alive process 50 may contribute to ranking backup DCN 14 as a first choice for redundancy should primary DCN 12 be determined unavailable, but may rank a second or third choice (not depicted in FIG. 3) for redundancy should backup DCN 14 be determined unavailable. Ranking backup DCNs for redundancy may be based on hardware, software, network access, previous status as a primary DCN, and/or previous failure rates. Thus, assignment of backup DCN 14 as a “primary” backup may change based on a myriad of dynamic factors.

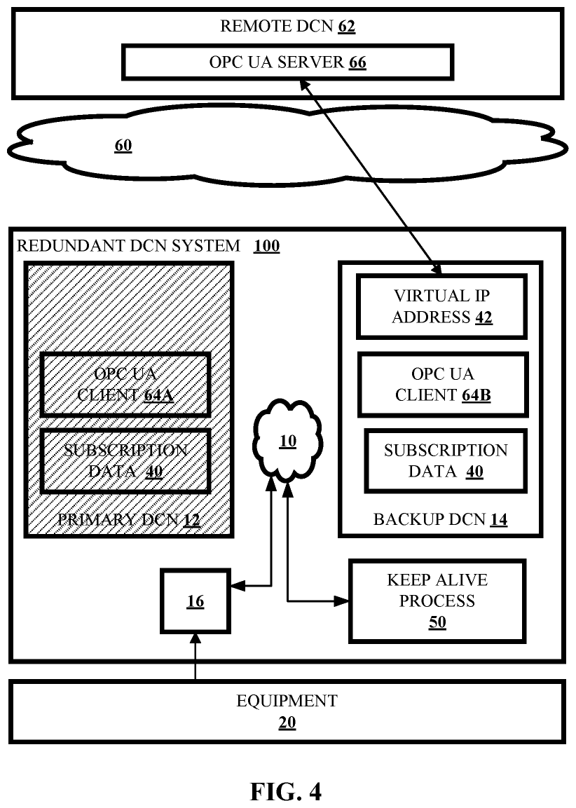

FIG. 4 schematically depicts components within the redundant DCN system 100 of FIG. 3 subsequent to one or more selected aspects of the present disclosure being implemented. In FIG. 4, primary DCN 12 has become unavailable (indicated by the cross hatching). As discussed herein, DCN unavailability may be caused by of automatic, manual, coincidental, or intentional factors. Primary DCN 12 may not be able to execute one or more functions based on unavailability.

To prevent and/or mitigate an impact on process automation due to unavailability of primary DCN 12, keep alive process 50 is configured to detect that primary DCN 12 has become unavailable, and reassign backup DCN 14 as a new primary DCN, which will take over one or more functions previously executed by primary DCN 12 subsequent to the reassignment. In some instances, new primary DCN 14 may take over fewer, alternative, or more functions relative to primary DCN 12. One or more of the new primary DCN 14 and the keep alive process 50 may contribute to determining which functions new primary DCN 14 is to carry out compared to former primary DCN 12. As indicated in FIG. 4 and discussed herein, reassignment may include virtual IP address 42 being transferred from primary DCN 12 to new primary DCN 14. This transfer may be subsequent to keep alive process 50 determining that primary DCN 12 is unavailable. The transfer of virtual IP address 42 need not be implemented directly from DCN 12 to DCN 14—indeed that might not be possible if primary DCN 12 has completely failed. In some implementations, the transfer of virtual IP address 42 from primary DCN 12 to backup DCN 14 may be implemented by, for instance, keep alive process 50.

Reassignment may cause or enable OPC UA client 64B hosted by new primary DCN 14 to immediately retrieve information from remote data feed(s) to which OPC UA client 64B is subscribed, such as feed(s) published by OPC UA server 66 hosted by remote DCN 62. Based on this retrieved data, OPC UA client 64B may output information (e.g., sensor reading, actuation instructions, etc.) to equipment 20.

Subsequent to reassignment of backup DCN 14 as a new primary DCN, remote DCN 62, I/O module 16, and/or equipment 20 may cease exchanging information with former primary DCN 12. Instead, remote DCN 62 and equipment 20 may exchange information with new primary DCN 14. Remote DCN 62 may affect this transition without any extra configuration by continuing to transmit data it publishes to the same virtual IP address 42, which now directs data to new primary DCN 14 instead of former primary DCN 12. I/O module 16 may affect this transition similarly, e.g., by directing all traffic to the same virtual IP address 42. Additionally or alternatively, I/O module 16 may affect this transition in other ways, e.g., by rerouting a communication channel from former primary DCN 12 to new primary DCN 14.

In some implementations, a DCN is configured to transmit subscription data 40 to one or more other DCNs whenever subscription data 40 is updated. Actively distributing subscription data 40 updates to the one or more other DCNs ensures that should a primary DCN 12 become unavailable each DCN in a redundant set has current subscription data 40 to operate with. This enables a reassigned DCN to quickly take over functions previously assumed by another DCN. For example, subscription data 40 of backup DCN 14 may be updated based on primary DCN 12 subscribing or unsubscribing to a new data feed published by a new or existing OPC UA server 66, or modifying an existing subscription.

Subsequent to backup DCN 14 being assigned a role of new primary DCN and driving equipment 20 based on one or more remote data feeds published by OPC UA server 66 hosted by remote DCN 62, former primary DCN 12 may become available once again. Upon becoming available once again, former primary DCN 12 may be reassigned once again as a primary DCN, and new primary DCN 14 may be reassigned once again to a backup DCN. Alternatively, upon becoming available once again, former primary DCN 12 may be reassigned as a backup DCN while new primary DCN 14 remains the same.

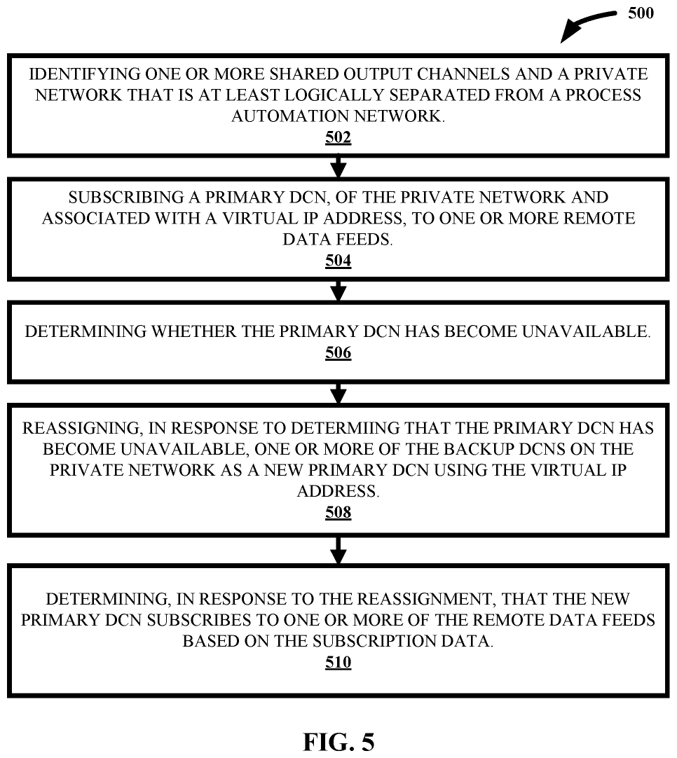

FIG. 5 includes a flowchart illustrating an example method 500 for performing aspects of the present disclosure. For convenience, the operations of the flow chart are described with reference to a system that performs the operations. This system may include various components of various computer systems. Moreover, while operations of method 500 are shown in a particular order, this is not meant to be limiting. One or more operations may be reordered, omitted, and/or added. Methods, systems, and apparatuses disclosed herein, including but not limited to method 500, may be implemented using one or more processors.

At block 502, the system identifies one or more shared output channels and a private network that is at least logically separated from a process automation network. These components may be part of a redundant DCN system (e.g., 100). While the private network may be included in a process automation network, it may be logically isolated, e.g., as indicated by its “private” status. In some implementations, the private network may be outside of a process automation network and may include one or more ingress/egress points for communicating with the outside process automation network. The one or more shared output channels may or may not be separated from the process automation network.

At block 504, the system subscribes a primary DCN, of the private network and that is associated with a virtual IP address, to one or more remote data feeds. This may include, for instance, a cross-platform client (e.g., OPC UA client 64) hosted by the primary DCN subscribing to one or more data feeds published by a remote cross-platform server (e.g., OPC UA server 66). In some implementations, the system may subscribe the primary DCN to one or more data feeds based on new or existing subscription data. As disclosed herein, assignment of a DCN as a primary DCN may be based on a myriad of factors, including hardware, software, location, accessibility, reliability, and configuration, of the DCN. The private network may communicatively couple a plurality of DCNs, of which the primary DCN is only one. For example, the private network may host one or more backup DCNs as discussed herein. As explained previously, at various points in time, such as periodically and/or in response to primary DCN 12 updating its subscription data, primary DCN 12 may provide (e.g., clone) its up-to-date subscription data to backup DCN 14, so that back DCN 14 can quickly take over should the need arise. In various implementations, although a primary DCN and a backup DCN may share identical subscription data, only the primary DCN may receive information from a remote data feed if that remote data feed is configured to provide information to the virtual IP address currently assigned to the primary DCN.

Returning back to FIG. 5, at block 506 the system determines whether the primary DCN has become unavailable. A DCN may become unavailable for a myriad of reasons, including malfunction, destruction, and disconnection. As disclosed herein, a keep alive process (e.g., 50) may be executed by one or more DCNs on the private network, and/or by a separate node inside or outside of the network. That is, the keep alive process may run concurrently across multiple devices, may run on a single device, or may be ran in part by multiple devices. The keep alive process may prevent and/or mitigate the impact of a DCN becoming unavailable, e.g., by determining that a DCN is available. Accordingly, in some implementations, a keep alive process may determine that a primary DCN is available and/or that one or more backup DCNs are available should the primary DCN become unavailable. As discussed herein, the keep alive process may execute continuously, periodically, on demand, in response to certain events, etc.

In response to determining that the primary DCN has become unavailable, at block 508, the system reassigns one or more of the backup DCNs on the private network as a new primary DCN using the virtual IP address. Reassignment of the one or more backup DCNs as a new primary DCN may enable a backup DCN-which previously received up-to-date subscription data from the primary DCN-to perform one or more functions of the primary DCN. This can be beneficial when, for example, the primary DCN contributed to an important process, and without the primary DCNs contribution, the process may fail, or be performed improperly or inefficiently. Thus, having a redundant set of DCNs in place should the primary DCN become unavailable can greatly benefit a process by creating a failsafe ensuring productivity, efficiency, and procedural correctness.

In some implementations a plurality of backup DCNs may be reassigned as a primary DCN by way of virtual IP addresses and/or virtual machines. For example, backup DCNs may include DCNs currently implementing other processes, such that only a subset of their entire processing capabilities would be available to assume functions of an unavailable primary DCN. Accordingly, processing capabilities of backup DCNs may be partitioned and/or reserved for backup purposes, while the remaining processing capabilities of backup DCNs may be dedicated to one or more other functions. This would enable a backup DCN, incapable of fully assuming a function of a now unavailable primary DCN by itself, to collaborate with one or more other DCNs and use a combined processing power to fully assume the function of the now unavailable primary DCN. Virtual IP addresses and virtual machines may be implemented in association with these partitions to represent I/O channels associated with the partitions as being from a “single” new primary DCN. As discussed, devices may be configured to only receive I/O from an identified device, and by masking the backup DCN partitions under a common virtual IP address, functions previously performed by a primary DCN may be efficiently assumed by a plurality of backup DCNs appearing as a single identified DCN.

At block 510, the system determines, in response to the reassignment, that the new primary DCN subscribes to one or more of the remote data feeds based on the subscription data. In some implementations, the new primary DCN subscribes to one or more of the remote data feeds to drive one or more of the shared output channels. As discussed herein, subscription data may be transferred among DCNs prior to failure of one or more of those DCNs. This shared subscription data may be used to determine which remote data feeds a backup DCN subscribes to and/or which output channels a backup DCN drives. As also discussed herein, a keep alive process may not only determine whether a DCN is unavailable, but may also determine whether a DCN is available. In some implementations, determining whether a new primary DCN is available may include determining whether a DCN is subscribed to one or more of the remote data feeds to drive one or more of the shared output channels. This may ensure that functions previously assumed by a former primary DCN are being executed by a new primary DCN.

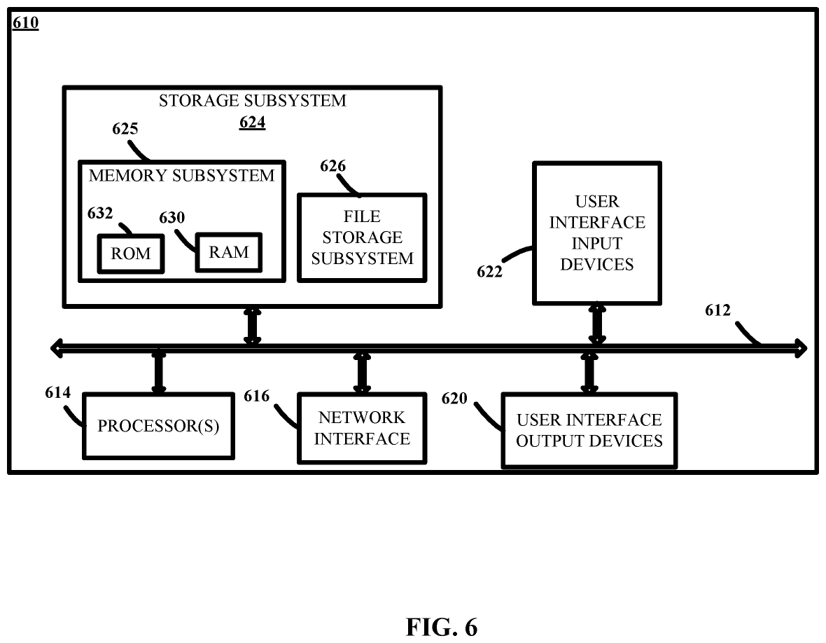

FIG. 6 is a block diagram of an example computing device 610 that may optionally be utilized to perform one or more aspects of techniques described herein. Computing device 610 typically includes at least one processor 614 which communicates with a number of peripheral devices via bus subsystem 612. These peripheral devices may include a storage subsystem 624, including, for example, a memory subsystem 625 and a file storage subsystem 626, user interface output devices 620, user interface input devices 622, and a network interface subsystem 616. The input and output devices allow user interaction with computing device 610. Network interface subsystem 616 provides an interface to outside networks and is coupled to corresponding interface devices in other computing devices.

User interface input devices 622 may include a keyboard, pointing devices such as a mouse, trackball, touchpad, or graphics tablet, a scanner, a touch screen incorporated into the display, audio input devices such as voice recognition systems, microphones, and/or other types of input devices. In general, use of the term “input device” is intended to include all possible types of devices and ways to input information into computing device 610 or onto a communication network.

User interface output devices 620 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computing device 610 to the user or to another machine or computing device.

Storage subsystem 624 stores programming and data constructs that provide the functionality of some or all of the modules described herein. For example, the storage subsystem 624 may include the logic to perform selected aspects of the method depicted in FIG. 5, as well as to implement various aspects depicted in FIGS. 1-4.

These software modules are generally executed by processor 614 alone or in combination with other processors. Memory 625 used in the storage subsystem 624 can include a number of memories including a main random-access memory (RAM) 630 for storage of instructions and data during program execution and a read only memory (ROM) 632 in which fixed instructions are stored. A file storage subsystem 626 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 626 in the storage subsystem 624, or in other machines accessible by the processor(s) 614.

Bus subsystem 612 provides a mechanism for letting the various components and subsystems of computing device 610 communicate with each other as intended. Although bus subsystem 612 is shown schematically as a single bus, alternative implementations of the bus subsystem may use multiple busses.

Computing device 610 can be of varying types including a workstation, server, computing cluster, blade server, server farm, or any other data processing system or computing device. Due to the ever-changing nature of computers and networks, the description of computing device 610 depicted in FIG. 6 is intended only as a specific example for purposes of illustrating some implementations. Many other configurations of computing device 610 are possible having more or fewer components than the computing device depicted in FIG. 6.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

1. A redundant distributed control node (DCN) system comprising:
one or more shared output channels;
a private network that is at least logically separated from a process automation network;
a primary DCN to subscribe to one or more remote data feeds based on subscription data and drive one or more of the shared output channels based on one or more of the remote data feeds; and
one or more backup DCNs that are communicatively coupled with the primary DCN via the private network,
wherein a virtual IP address, used by the redundant DCN system to exchange data over the process automation network, is transferable between the primary DCN and one or more of the backup DCNs, and
wherein the primary DCN is to transmit, to one or more of the backup DCNs via the private network, the subscription data of the primary DCN, wherein the subscription data is operable to subscribe one or more of the backup DCNs to one or more of the remote data feeds; and
a keep alive process to determine whether the primary DCN has become unavailable, and in response to determining that the primary DCN has become unavailable, trigger reassignment of one or more of the backup DCNs as a new primary DCN,
wherein the new primary DCN subscribes to one or more of the remote data feeds based on the subscription data to drive one or more of the shared output channels, and
wherein reassignment as the new primary DCN includes transferring the virtual IP address from the primary DCN to the new primary DCN.

2. The redundant DCN system of claim 1, wherein the keep alive process is hosted on one or more of the backup DCNs.

3. The redundant DCN system of claim 1, wherein the keep alive process is hosted on each DCN of the one or more backup DCNs.

4. The redundant DCN system of claim 1, wherein the keep alive process is hosted on a processing node, separate from the one or more backup DCNs.

5. The redundant DCN system of claim 4, wherein the processing node is integral with the redundant DCN system.

6. The redundant DCN system of claim 1, wherein the primary DCN is configured to transmit the subscription data periodically.

7. The redundant DCN system of claim 1, wherein the primary DCN is configured to transmit the subscription data whenever the subscription data of the primary DCN is altered.

8. The redundant DCN system of claim 7, wherein the subscription data of the primary DCN is altered responsive to the primary DCN subscribing to a new node.

9. The redundant DCN system of claim 7, wherein the subscription data of the primacy DCN is altered responsive to the primary DCN modifying an existing subscription.

10. The redundant DCN system of claim 1, wherein the new primary DCN loads the subscription data responsive to a determination that the primary DCN has become unavailable.

11. The redundant DCN system of claim 10, wherein the new primary DCN, responsive to loading the subscription data, subscribes to one or more of the remote data feeds, and drives one or more of the shared output channels based on one or more of the remote data feeds.

12. The redundant DCN system of claim 1, wherein subsequent to reassignment of one or more of the backup DCNs as the new primary DCN, and responsive to the primary DCN being made available again, the primary DCN is assigned as another backup DCN, of the one or more backup DCNs, while the virtual IP address remains reassigned to the new primary DCN.

13. The redundant DCN system of claim 1, wherein the private network is implemented using one or more of ethernet, serial, or bus communication technology.

14. The redundant DCN system of claim 1, wherein the primary DCN or the new primary DCN, share the virtual IP address with another DCN.

15. The redundant DCN system of claim 1, wherein the keep alive process determines a status of the primary DCN periodically.

16. The redundant DCN system of claim 1, wherein the keep alive process determines a status of the primary DCN in response to a triggering event.

17. A method implemented by one or more processors, the method comprising:
identifying one or more shared output channels and a private network over which one or more backup DCNs are communicatively coupled with a primary DCN;
determining, based on a keep alive process, whether the primary DCN, that is subscribed to one or more remote data feeds to drive one or more of the shared output channels based on one or more of the remote data feeds, has become unavailable,
wherein the primary DCN is subscribed to the one or more remote data feeds based on subscription data and transmits the subscription data to one or more of the backup DCNs via the private network; and
causing, in response to determining that the primary DCN has become unavailable, reassignment of one or more of the backup DCNs as a new primary DCN, wherein reassignment as the new primary DCN includes transfer of a virtual IP address of the primary DCN to the new primary DCN, and wherein the new primary DCN subscribes to one or more of the remote data feeds based on the subscription data.

18. The method of claim 17, wherein the keep alive process is hosted on one or more of the backup DCNs.

19. A redundant distributed control node (DCN) system comprising:
one or more computers comprising one or more processors, and one or more storage devices storing instructions that are operable, when executed by the one or more computers, to cause the one or more processors to perform operations comprising:
determining whether a primary DCN, that is currently or formerly subscribed to one or more remote data feeds to drive one or more shared output channels based on one or more of the remote data feeds, has become unavailable;
identifying one or more backup DCNs that are communicatively coupled with the primary DCN via a private network logically separated from a process automation network associated with the redundant DCN system,
wherein a virtual IP address, used by the redundant DCN system to exchange data over the process automation network, is transferable between the primary DCN and one or more of the backup DCNs, and
wherein subscription data of the primary DCN is transmitted to one or more of the backup DCNs via the private network; and
reassigning, in response to determining that the primary DCN has become unavailable, one or more of the backup DCNs as a new primary DCN, wherein reassignment as the new primary DCN includes transferring the virtual IP address from the primary DCN to the new primary DCN.

20. The redundant distributed control node (DCN) system of claim 19, wherein the new primary DCN subscribes to one or more of the remote data feeds based on the subscription data.
